(19) United States
(12) Patent Application Publication
(10) Pub. No.: US 2006/0207450 A1
(43) Pub. Date: Sep. 21, 2006

(54) Drive device and method for controlling a unit of a printing press

(76) Inventor: Detlef Alfons Buechner, Dorfprozelten (DE)

Correspondence Address: Striker Striker & Stenby, 103 East Neck Road, Huntington, NY, 11743, US

(21) Appl. No.: 10/553,299

(22) PCT Filed: Mar. 18, 2004
(86) PCT No.: PCT/EP04/50323

§ 371 Date: Oct. 14, 2005

(30) Foreign Application Priority Data
Apr. 16, 2003 (DE) 10317570.9

(51) Int. Cl. B41F 5/00

(52) U.S. Cl. 101/216

(57) ABSTRACT

A drive device of a printing press comprises a virtual guide axle (a, b) for specifying a set angular position of a drive (08) of at least one unit (01, 02, 03, 04, 06, 07) driven by its own drive motor (M). At least one circuit (15, 20) is connected to the guide axle (a, b) and enables the conversion of the temporally changing datum for the angular position of the guide axle position (Φ) into a pulse train provided in the form of output signals (I(t), l₀(t)).

The invention relates to a drive device and method for controlling a unit or subassembly of a printing press according to the preamble to claims 1 and 24.

DE 37 30 625 A1 has disclosed a drive device in which each printing unit and/or the folding unit of a printing press is associated with a primary station, which receives operating set point values from a master control unit and transmits them to the subordinate stations of relevant units.

DE 42 14 394 C2 has disclosed a drive device for a longitudinal shaftless printing press in which the folding unit is connected to printing station groups via a data bus. The folding unit supplies its position reference to the printing station groups. A shared drive control unit for the drives of the individual printing station groups finely adjusts these drive devices in relation to one another as well as in relation to the folding unit.

U.S. Pat. No. 4,495,582 A has disclosed using a shared drive motor to drive a printing press line, an incremental position transducer being situated in the vicinity of a hole punch. Signals from this transducer are consulted, e.g. as a reference for the circumferential register.

The object of the present invention is to create a drive device and a method for controlling a subassembly of a printing press.

The object is attained according to the present invention by means of the characterizing features of claims 1 and 24.

In printing presses, controlling various subassemblies such as stackers, driers, register controllers, etc. requires the use of actual speed values or position values of the printing press in a wide variety of forms, e.g. analog, incremental with various resolutions, and with or without a zero pulse. This form also depends, among other things, on the supplier. In order to be able to generate the appropriate signals, a number of different transducers have been physically situated in one or more of the subassemblies and have generated the data in the desired form for subassemblies not coupled to a mechanical and/or virtual longitudinal and/or vertical shaft.

The circuit according to the present invention and its connection to a virtual leading axle is advantageous, particularly with regard to its ability to be parameterized and the possibility for outputting signals that have been parameterized in various ways.

Since the signals are not obtained from transducers physically situated in subassemblies, the design is distinguished by a high degree of flexibility, space savings, and a reduced sensitivity to interferences that would arise, for example, due to out-of-round subassemblies or transducers.

The advantages that can be achieved with the invention are particularly comprised in the fact that drives of subassemblies whose controllers require position data as input values and drives of subassemblies that are not directly coupled to the leading axle can be flexibly and inexpensively connected to the leading axle.

The position reference from the electronic leading axle for the print units and optionally for the folding unit as well as a cycle preset for other subassemblies reduces the occurrence of errors in comparison to mechanical measuring and/or drive systems.

The decoupling and reference to a shared leading axle makes it possible, both for the drives of the printing units and for the folding unit, to adjust offset values in relation to the leading axle and in an advantageous embodiment, to preset them for a particular production (web routing). The signals for additional subassemblies can be freely parameterized.

In one embodiment, it is advantageous to read the chronological change in the leading axle position at a suitable location directly in the signal line that carries the leading axle position, e.g. close to the subassembly, and to appropriately convert it by means of the circuit. In another embodiment, the conversion of the chronological change into a pulse train, e.g. with the aid of a card, occurs already in a drive control unit that presets the leading axle position or in a computing and data processing unit connected to it.

In one advantageous embodiment, an offset value in relation to the leading axle can be adjusted or preset for each rotary drive of the printing units (at least the drives of the forme cylinder that can be driven independently of other forme cylinders) and of the folding unit. These offset values are preferably set in the respective drive controller of the drive and stored there in the form of an offset. The presetting of a particular offset value can, for example, be input and/or changed in a control center and/or stored there for a particular production and correspondingly called up and then transmitted to the drive controllers and subordinate drive control units.

Exemplary embodiments of the invention are shown in the drawings and will be described in greater detail below.

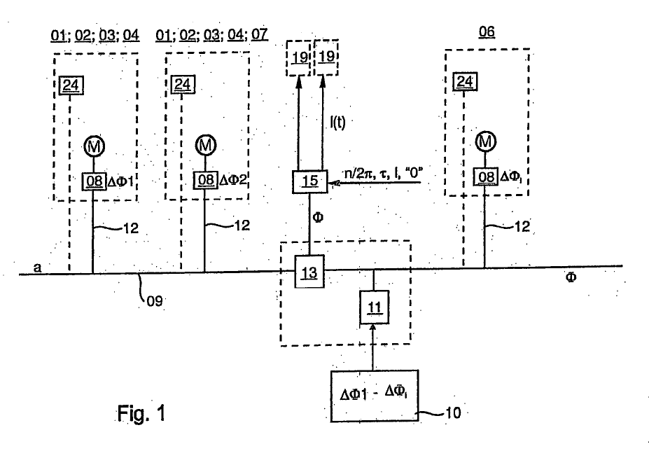

FIG. 1 shows a first exemplary embodiment of the drive device;

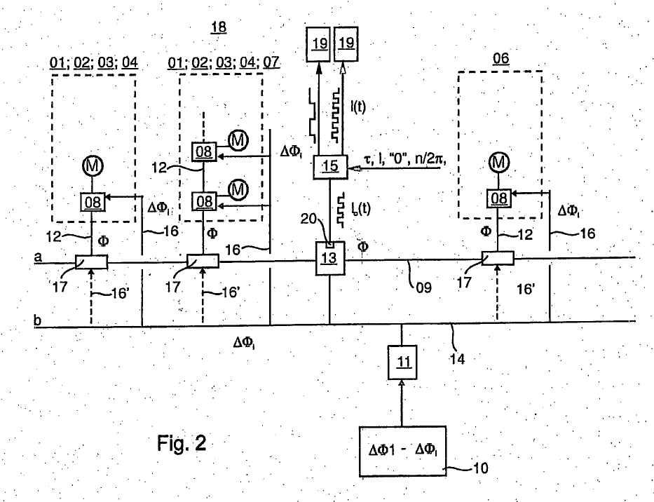

FIG. 2 shows a second exemplary embodiment of the drive device;

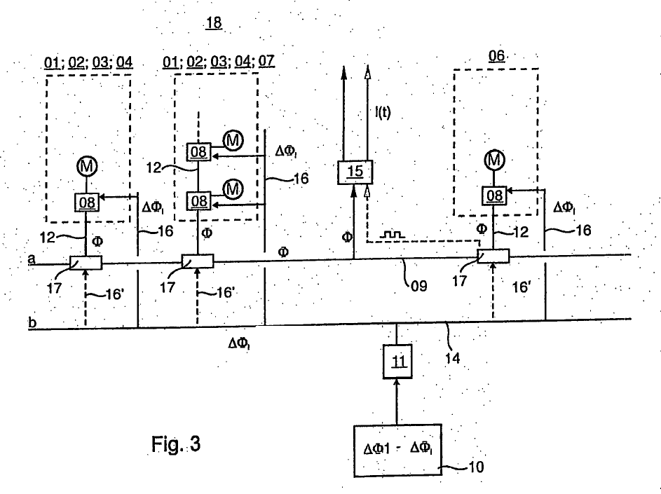

FIG. 3 shows a third exemplary embodiment of the drive device;

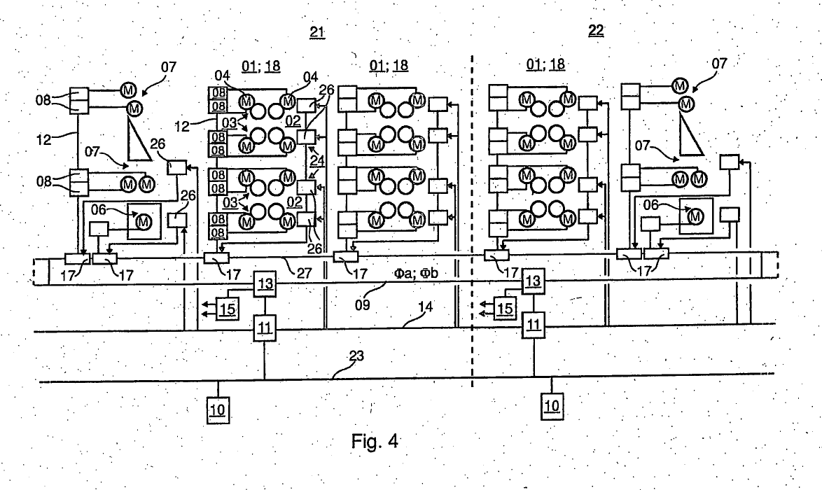

FIG. 4 shows a fourth exemplary embodiment of the drive device;

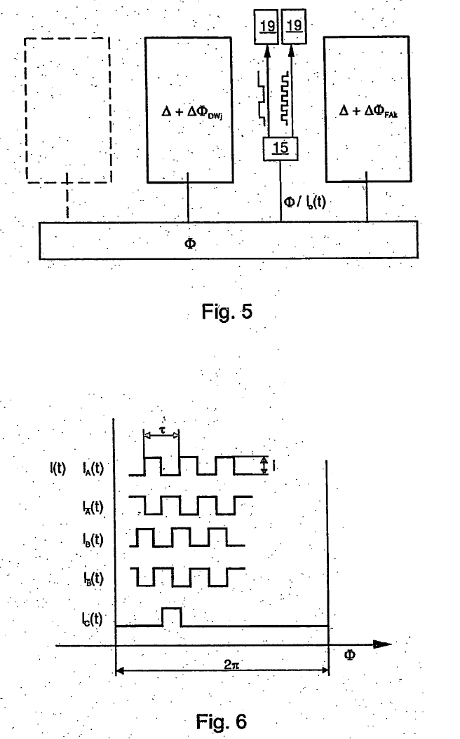

FIG. 5 is a schematic depiction of the leading axle for the relative position of drives and the circuit during operation;

FIG. 6 is an exemplary depiction of a set of pulse trains.

A processing machine for web-shaped materials, e.g. a printing press, in particular a rotary printing press, has a number of units 01; 02; 03; 04; 06; 07 that are each mechanically driven independently of one another by a respective drive motor M. These independently driven units 01; 02; 03; 04; 06; 07 can cooperate directly or indirectly with a web traveling through the printing press, e.g. the web of print stock, and must therefore be aligned in their positions in relation to the web and to one another. These units 01; 02; 03; 04; 06; 07 can be printing towers 01, individual printing units 02, individual printing-couples 03, or individual cylinders 04, in particular individual forme cylinders 04, of printing couples 03. A unit of this kind can also be a unit 06 that processes the web after printing, in particular a folding unit 06, or for example can include perforating units, hole punches, collating devices, cutting devices, etc. Such an independently driven unit can also be one or more conveying elements 07, e.g. draw rolls, skip slitters, register rolls, etc.

FIG. 1 shows three such units 01; 02; 03; 04; 06; 07 that are mechanically driven independently of one another by drive motors M. The two units shown on the left can, for example, be printing towers 01, printing units 02, printing couples 03, or cylinders 04. The middle unit or another unit that is not shown can, however, also be a conveying element 07. The unit on the right represents, for example, a processing unit 06, in particular the folding unit 06.

The drive motors M each have a drive 08 with drive control; these drives 08 are connected to one another and to a computing and data processing unit 11, e.g. a computer 11, via at least one signal line 09. The computing and data processing unit 11 can also have an operating unit 10 or be connected to an operating unit 10, e.g. a control center 10. The drives 08 (or controllers 08) can in principle be connected directly in series (not shown) in a ring or bus structure or, in the manner shown, can be connected to signal line 09 in a tree structure by means of signal lines 12.

The at least one signal line 09 conveys signals of a leading axle position Φ, which is preset by a computing unit 13, e.g. a master drive control unit 13. The signal line 09, together with the computing unit 13, represents the so-called virtual leading axle a (electronic shaft) for the units 01; 02; 03; 04; 06; 07 connected to it, in relation to which the units 01; 02; 03; 04; 06; 07 are oriented in terms of their location or position. This leading axle position Φ is transmitted to the drives 08 as a preset (reference value).

The computing and data processing unit 11 supplies presets for the desired production speed to the master drive control unit 13 and is thus connected to the drives 08 via the master drive control unit 13, the signal line 09 (cross communication), and the signal lines 12.

Each of the controllers 08 can be supplied with a specific offset ΔΦₗ, e.g. the angular offset ΔΦₗ, which establishes a permanent, but changeable, offset in relation to the leading axle position Φ. This offset ΔΦₗ? can be input directly into the controller 08 and/or via a computing and data processing unit 11 and/or can be stored in and called up from a memory in the computing and data processing unit 11 for specific operating situations, in particular specific web routings. If the signal line 09 is correspondingly embodied, for example in the form of a broadband bus or a broadband network, then the data regarding the respectively preset and established offset ΔΦₗ and the “rotating” leading axle position Φ can be sent via the shared signal line 09. The signal line 09 can also be respectively connected to a control system 24, which controls and/or regulates the various actuators and drives—apart from the drive motors M—of the printing units 02, printing couples 03, folding units 06, e.g. ink supply, adjusting movements of rollers and/or cylinders, damping units, positions, etc. (connection depicted with dashed lines).

Before the beginning of production, the respective offset ΔΦₗ? is transmitted by the control center 10 or the computing and data processing unit 11 to the drives 08 and stored there. In an advantageous embodiment, the offset ΔΦₗ can be changed during operation or production at the drive 08 itself, but preferably by means of the computing and data processing unit 11.

In one variant, the offset values ΔΦₗ?? for the different drives 08 can also be stored in the master drive control unit 13. In this case, the signal lines 09; 12 (or in series: only 09) supply each drive 08 with a preset in the form of the sum of the rotating leading axle position Φ and the specific stored offset value ΔΦₗ of the respective drive 08.

As a result, all of the drives 08, e.g. the drives 08 of the two first units embodied for example in the form of printing towers 01 and the drive 08 of the unit embodied in the form of a folding unit 06, respectively follow the rotating leading axle position Φ from the master drive control unit 13, each with an established offset value ΔΦₗ relative to the absolute position of the leading axle position Φ The drive control unit 13 that presets the leading axle position Φ consequently functions as a master, which is essentially independent of the units, for all drives 08 coupled to this leading axle a.

The virtual leading axle a (electronic shaft) is now connected to a circuit 15 from which one or more pulse-shaped output signals l(t), e.g. in the form of pulse trains l(t), can be transmitted to drives of other subassemblies 19. The circuit 15, e.g. embodied in the form of an emulator, converts the rotating leading axle position Φ, i.e. the chronologically changing datum for the angular position, into a pulse train. The circuit 15 can, as shown in FIG. 1, receive current values regarding the leading axle position Φ at its input from the drive control unit 13 or from the computing and data processing unit 11, convert these into digital and/or analog pulse trains l(t) and output them at an output. Pulse trains l(t) of this kind are schematically depicted in FIG. 6. As depicted in FIG. 6, a pulse train l(t) can also have a set of correlated pulse trains l(t), which as a whole, indicate the direction of a movement, increase reliability, and define a zero point. Thus, for example, the output signal l(t) has a pulse train l_{A}(t) and its inversion, as well as a chronologically offset pulse train l_{B}(t) and its inversion. In addition, the output signal also contains a signal l_{C}(t) for identifying a zero point.

Different subassemblies 19 and/or different manufacturers currently require pulse trains l(t) with various numbers of pulses per rotation n/2π or periods with various period lengths τ and/or various amplitudes l and/or various compositions of a set of pulse trains lₙ(t) and/or the presence of a zero point “0”. It is now possible to adjust the circuit 15 for one or more of the above-mentioned parameters n/2π, τ, l, lₙ(t), “0”. This can occur through an interface by means of a PC, by means of a so-called jumper box, or by means of the computing and data processing unit 11. At the very least, the circuit 15 permits adjustment (parameterization) of the incremental resolution between the rotating leading axle a; b and an angular-position transducer of a subassembly 19 and/or its drive, which is to be controlled via the circuit 15. This parameterization can be comprised, for example, of inputting a resolution ratio, inputting one or both values of the leading axle resolution or subassembly resolution. It is thus possible in this case to establish whether an angular position transducer of the subassembly 19 and/or its drive motor is embodied, for example, with 1024 increments per rotation or with a different number n of them, e.g. 512 or 4084, or, for example, a factor is given between the number of these increments and that on which the leading axle is based. In an advantageous modification, the circuit 15 has a number of subcircuits, each with parameters n/2π, τ, l, lₙ(t), “0” that can be parameterized and a number of outputs. This permits the generation of pulse trains l(t) of one or more fictional transducers that are custom-made for the drives of subassemblies 19.

By contrast with FIG. 1, in FIG. 2, the leading axle position Φ is converted—already in the drive control unit 13 or a circuit 20 provided therein, e.g. in a card—into a first pulse train l₀(t) with a fixed, definite shape and number of pulses or voltage per rotation n/2π, which is supplied to the input of the circuit 15. In the circuit 15, in conjunction with the existing parameters or parameter sets n/2π, τ, l, lₙ(t), “0”, the output signal l(t) or output signals l(t) is/are generated and transmitted to the subassembly 19 or respective subassemblies 19. As indicated in FIG. 2, these can each be parameterized individually.

For the transmission of the respective offset ΔΦₗ (and possibly other relevant data), by contrast with FIG. 1, in FIG. 2, a signal line 14 is provided, which is separate from the signal line 09. In addition, a communications node 17, e.g. a subordinate drive control unit 17, is respectively provided for the connection between the signal line 09 and the signal line 12.

The computing unit 13 for presetting the leading axle position Φ is connected via the signal line 14 to the computing and data processing unit 11, from which it receives, for example, other presets with regard to production speed and/or current desired rotation speed. The current leading axle position Φ is then preset by the master drive control unit 13 and fed to the signal line 09. From there, the data regarding the rotating leading axle position Φ is transmitted via the communications nodes 17 to the signal line 12 and from there, is supplied directly to the drives 08 relevant to current production. A communications node 17 can, as shown in FIG. 2, be connected via the signal line 12, e.g. a network 12 with a ring or bus topology, to a number of subordinate units each driven by a respective drive motor M, e.g. printing units 02, printing couples 03, or cylinders 04. The subordinate units combined in this way via a communications node 17 are referred to below as a group 18 of units or subassemblies that are mechanically driven independently of one another. In this case, the communications nodes 17 transmit, for example, the leading axle position Φ from the signal line 09 to the drives 08 of all subordinate units (involved in the production), e.g. printing units 02 or printing couples 03 of this group 18.

In the example shown in FIG. 2, the middle unit represents such a group 18 of several subunits, e.g. two printing units 02, two printing couples 03, or two conveying elements 07, etc., whose drives 08 both receive the leading axle position Φ via the communications node 17.

In a first embodiment, the production-specific offset values ΔΦₗ are transmitted by the computing and data processing unit 11 or by the control center 10 to the individual drives 08 of the units, where they are stored and processed together with the leading axle position Φ. The transmission here occurs, for example, in the tree structure leading from the signal line 14 via one shared signal line 16 per subassembly (or in a star-shaped arrangement via a number of separate signal lines 16 per subassembly) toward the drives 08 (solid lines).

In a second embodiment (dashed lines), the offset ΔΦₗ is transmitted from the signal line 14 via logical connections 16′ directly or indirectly to the respective communications nodes 17. The physical embodiment of the logical connections 16′ can be embodied directly or indirectly in the form of additional connections such as bus couplers, bridges, etc., or, for example, via a control system 24 shown in FIGS. 1 or 3. In this case, the signal line(s) 16 can be omitted. In a first version of this embodiment, the specific offset ΔΦₗ is transmitted by the communications node 17 to the corresponding drive 08 solely via the signal line 12 and is stored there.

In a second, advantageous version, the communications node 17 is embodied in the form of a subordinate drive control unit 17 equipped with a memory and its own intelligence in such a way that offset values preset for the associated drives 08 and the specific production are stored therein and the drives 08 involved in the production are each furnished with specific leading axle positions Φₗ′(Φₗ′=Φ+ΔΦₗ) specifically addressed to them, e.g. as a desired angular position Φₗ′, by the subordinate drive control unit 17. The correlation indicated is intended here and below merely to illustrate the principle. Naturally, when tracking the specific leading axle position Φₗ′, the sizes of the subassemblies to be driven, etc. must be taken into account so that a real correlation comprises, for example, other subassembly-specific factors.

Thus on the one hand, the computing and data processing unit 11 communicates with the drives 08 via the master drive control unit 13, the signal line 09 (cross communication), the respective communications node 17, and the signal lines 12, e.g. busses 12. In this way, it is also possible to exchange data regarding the configuration (coupling of printing units 02 and/or printing couples 03) or the joint production speed.

In order to transmit the data regarding the specific offset ΔΦₗ, the drive control unit 13 supervised by to the computing and data processing unit 11 communicates with the corresponding drives 08 as described above either via the signal line 14 and the signal lines 16 or via the signal line 14, the logical connection 16′, the communications nodes 17, and the signal lines 12.

In the exemplary embodiment according to FIG. 2, the drive motors M of the group 18 are connected to one another and to the subordinate control unit 17. The subordinate control units 17 of the groups 18 or units are connected to one another and to the master drive control unit 13 via at least one signal line 09. In addition, in order to transmit the data regarding the specific offset values ΔΦₗ, the computing and data processing unit 11 here is connected to the drives 08 or the communications nodes 17 via at least one signal line 14.

In an advantageous embodiment, the signal line 09 is embodied in the form of a real-time capable connection 09 with a fixed timeframe for real-time-relevant data and deterministic time behavior, e.g. in the form of an ARCnet. The connection 9 can additionally contain a channel in which for example non-real-time data—such as the transmission of specific offset values ΔΦₗ in the embodiment according to FIG. 1 and/or data regarding the configuration, production speed, etc.—can be transmitted in accordance with the embodiment in FIG. 1.

In another advantageous embodiment, the signal line 12 can also be embodied in the form of a real-time capable connection 12 with a fixed timeframe for real-time-relevant data and deterministic time behavior, e.g. in the form of an ARCnet. The connection 12 can additionally contain a channel in which for example non-real-time data—such as the transmission of the offset ΔΦₗ and/or data regarding the configuration, production speed, etc.—can be transmitted.

The signal line 14 and 16 is preferably embodied as a network 14, 16 or as part of a network 14, 16. In another advantageous embodiment, this network 14, 16 can once again function as a network 14, 16 in accordance with a deterministic access behavior, e.g. in the form of an ARCnet. The network 14, 16 can, however, also be embodied in the form of a high-speed network 14, 16 with stochastic access behavior, e.g. Ethernet. It should, however, at least be possible to transmit data in half duplex mode.

FIG. 3 shows an exemplary embodiment in which the virtual leading axle is preset by one of the drive control units 17 previously referred to as “subordinate”, functioning as a master. For example, this is the drive control unit 17 of the folding unit 06. Once again, as shown in FIG. 1, the leading axle position Φ can be supplied to the input of the circuit 15, which converts it in the above-described manner. In a version depicted with dashed lines, the input of the circuit 15 has already been supplied with a converted, definite pulse train l₀(t), which was correspondingly generated in the drive control unit.

The leading axle position Φ or the converted pulses, however, can also be supplied to the circuit 15 from other locations on the virtual leading axle a; b or another drive control unit 17.

FIG. 4 shows an example for the driving of a printing press, with a number of printing towers 01, three in this case, each of which has a number of printing couples 03, double printing couples 03 in this case. The printing couples 03 of a printing tower 01, together with their drives 08 and the motors M, combine to form a group 18, in particular a printing station group 18, which is connected to the signal line 09 via the subordinate drive control unit 17 of this group 18 . The drive control unit 13 can, however, also manage subgroups 02 of printing couples 03, e.g. printing units 02 or other sections with associated drives 08. This signal line 09 is also connected to additional units that have their own subordinate drive control unit 17, e.g. one or more conveying elements 07 and/or one or more folding units 06. The signal line 09 here is advantageously embodied in the form of a ring topology, in particular a double ring, and has one or more of the properties mentioned above in connection with FIG. 2.

In FIG. 4, each circuit 15 communicates with a respective master drive control unit 13, which supplies it with the leading axle position Φₐ; Φ_{b} or the pulse train l₀(t). It is also possible to connect a circuit 15 to the shared signal line 09 in such a way that the circuit 15 (or its individual subordinate circuits for various outputs) can then be associated with one or the other leading axle a; b. This can even occur by means of a parameterization for the individual output or outputs.

The signal line 09 is connected to several master drive control units 13, in this case two, which can feed different signals of a respective leading axle position Φₐ; Φ_{b} of a leading axle a; b into the signal line 09. This is advantageous, for example, if it is necessary for the printing press and/or its printing towers 01 and/or printing units 02 and/or printing couples 03 and the associated folding units 06, as well as the conveying elements 07 to have the capacity to be associated with a number of sections 21; 22 that can be operated separately or conjointly. It is also possible, however, for productions and web routings to extend beyond the section division indicated with dashed lines in FIG. 4 and lead from printing units 03 of the one section 21 into printing units 03 of the other section 22 and/or folding unit 06 of the other section 22. The individual printing towers 01 can, for example, be associated with different folding units 06. It is also possible within a single printing tower 01 to associate subgroups, e.g. printing units 03, with different webs that have different web routings, which can be conveyed to a shared folding unit 06 or to totally separate folding units 06. It is therefore logical not to consider the sections 21; 22 as fixed units.

The master drive control units 13 each receive their presets regarding starting point and production speeds of the respective section 21; 22 and/or web routing from a respectively associated computing and data processing unit 11, which units 11 are in turn connected to at least one control center 10. In an advantageous embodiment, the two computing and data processing units 11 are connected to each other via the signal line 14 and to another signal line 23, e.g. a network 23 that interconnects a number of control centers 10, in this case two. In an advantageous embodiment, this network 23 can be operated as a high-speed network 23 in accordance with a stochastic access behavior, e.g. Ethernet.

For the relevant production, the computing and data processing unit 11 transmits the offset values ΔΦₗ relevant for the individual drives 08 via the signal line 14 to the subordinate drive control units 17 associated with the respective drive 08 and in an advantageous embodiment, is stored there as described in connection with FIG. 2 and processed along with the leading axle position Φa; Φb to produce the leading axle positions Φₗ′. If subgroups, e.g. printing units 03, of a group 18, e.g. a printing tower 01, are associated with two different webs, then the leading axle position Φa; Φb of the leading axle a or b respectively associated with the relevant drive 08 is processed by the subordinate drive control unit 17 together with the offset value ΔΦₗ preset for this web routing, depending on the association of the relevant printing station to one or the other web.

The transmission to the subordinate drive control units 17 in this example, however, does not occur directly but via a control system 24, which is associated with the respective group 18 or with a unit that has its own subordinate drive control unit 17, e.g. the folding unit 06. The control system 24 controls and/or regulates, for example, the various actuators and drives—apart from the drive motors M—of the printing units 02 and/or printing station groups 18 and/or printing couples 03 and/or folding units 06, e.g. e.g. ink supply, adjusting movements of rollers and/or cylinders, damping units, positions, etc. The control system 24 has one or more (in particular memory-programmable) control units 26. This control unit 26 is connected to the subordinate drive control unit 17 via a signal line 27. In the event that several control units 26 are provided, these are also connected to one another by means of the signal line 27.

In an advantageous embodiment, the control system 24 and/or its control unit(s) 26 is/are detachably connected to the signal line 14 by means of couplers that are not shown, e.g. bus couplers. This makes it possible for the group 18 to be operated in a self-contained manner in principle, the drives 08 being controlled via the branch containing the subordinate drive control unit 17 with the signal line 12, and the other functions of the group 18 being controlled via the branch containing the control system 24. Set point values, actual values, and deviations can be received and transmitted via the coupler. In this case, the subordinate drive control unit 17 assumes the role of furnishing a leading axle position Φ. For this reason, and for redundancy reasons, it is advantageous if all of the subordinate drive control units 17 are designed with the possibility of generating and presetting a leading axle position Φ.

In the embodiment according to FIG. 4, the offset values ΔΦₗ are consequently supplied by the signal line 14 via the respective control system 24 to the relevant subordinate drive control unit 17. As described in connection with the exemplary embodiment according to FIG. 2, the offset values ΔΦₗ can alternatively be transmitted from there to the drives 08 and can be stored and processed there.

In the exemplary embodiments according to FIGS. 2 and 4, the master drive control unit 13 can be omitted if one or more groups 18 or one of the units equipped with its own subordinate drive control unit 17 (e.g. a folding unit 06) has a subordinate control unit 17. It is then possible for one of the drive control units 17 to preset the virtual leading axle and/or leading axle position Φ. In this case, the circuit 15 once again receives its input signal (leading axle position Φ or converted pulse train l₀(t)) either from the signal line 09 or from the relevant drive control unit 17.

In the embodiments described above, at least one drive control unit 13; 17 or unit presets at least one leading axle position Φ; Φa; Φb in relation to which the drives 08 of the various units, which are mechanically driven independently of one another, are oriented in terms of their position. Each of these drives 08 can be associated with a specific offset value ΔΦₗ, which respectively expresses the relative desired position in relation to the leading axle position Φ; Φa; Φb of the assigned leading axle a; b. Thus for a specific production, for example, all of the drives 08, which are mechanically driven independently of one another, of the printing towers 01 (and/or printing units 02 and/or printing couples 03) and the associated drive 08 of the folding unit 06 and possibly conveying devices 07 are each associated with respective offset values ΔΦₗ with regard to the leading axle a; b relevant to the production. If the leading axle a; b receives its leading axle position Φ; Φa; Φb from one of the units, e.g. from the folding unit 06, at the beginning or even as the process continues, then the remaining units are associated with a specific offset value ΔΦₗ.

These offset values ΔΦₗ are based essentially on purely geometrical relationships. On the one hand, they depend on the selected web routing, i.e. the web path between the individual units. On the other hand, they can depend on a random or selected zero position of the individual drive 08. This latter trait is not necessary for the individual drive 08 if its defined zero position coincides with the zero position of the leading axle a; b or if the leading axle a; b receives its position from this unit.

The value, e.g. in mm, for the offset ΔΦₗ of the individual drives 08 of the printing couples 03 and folding unit 06 are stored in the control center 10 or in the computing and data processing unit 11. It is also advantageous if this set of offset values ΔΦₗ (e.g. in mm) is stored with reference to data for the specific web routing and/or vice versa.

For automation purposes, the manually determined offset values ΔΦₗ can be stored by the control center 10 as a function of the web routing and called up when this production is repeated and once again transmitted to the drives 08 in the above-described way.

If the printing press and/or the relevant unit is then operated, then the drives 08 coupled to the leading axle a; b via the angular positions, with their zero position plus the added offset ΔΦₗ, correspond to the leading axle position Φ; Φa; Φb and are consequently always in the correct position. The drives 19 that are not directly coupled are supplied with the converted pulse train l(t) from the circuit 15.

FIG. 5 schematically depicts this situation in which the leading axle a; b shared by the printing couple 03 and the folding unit 06 the leading axle position Φ; Φa; Φb, the printing couple 03 and/or the drive 08 that drives it the position Φ +ΔΦ_{DWj}, i.e. the sum of the leading axle position Φ; Φa; Φb and the offset ΔΦ_{DWj} specific to j^{th} printing couple 03 (in this web routing), and the folding unit 06 and/or its drive 08 the position Φ+ΔΦ_{FAk}, i.e. the sum of the leading axle position Φ; Φa; Φb and the offset ΔΦ_{DWj} specific to k^{th} folding unit 06 (in this web routing). As has already been explained above, the interrelationships represent the simplified principle without further subassembly-specific factors. As explained above, the circuit 15 receives either the leading axle position Φ; Φa; Φb or an already-converted pulse train l₀(t) and at its output or outputs, generates corresponding output signals l(t) for the subassembly 19 or subassemblies 19 with a corresponding parameterization.

In an advantageous embodiment, it is possible to carry out a correction of the respective offset value ΔΦₗ and/or a parameterization in the control center 10 and/or the computing and data processing unit 11 and/or in the circuit 15, even during a production run or while the machine is running.

### REFERENCE NUMERAL LIST

01 unit, printing tower
02 unit, printing unit, subgroup
03 unit, printing couple, double printing couple
04 unit, cylinder, forme cylinder
05 —
06 unit, processing unit, folding unit
07 unit, conveying element
08 drive, controller
09 signal line, connection, network
10 operating unit, control center
11 computing and data processing unit, computer
12 signal line, network, busses
13 computing unit, master drive control unit
14 signal line, network
15 circuit, second
16 signal line, connection, network
17 communications node, subordinate drive control unit
18 group, printing station group
19 subassembly
20 circuit, first
21 section
22 section
23 signal line, network
24 control system
25 —
26 control unit
27 signal line
16′ logical connection
l(t) pulse train, output signal
l₀(t) pulse train, output signal
lₙ(t) pulse train
l_{A}(t) pulse train
l_{B}(t) pulse train
l_{C}(t) signal
Φ leading axle position
Φa leading axle position
Φb leading axle position
ΔΦₗ offset, offset value, angular offset
ΔΦ_{DWj} offset, j^{th} printing couple
ΔΦ_{FAk} offset, k^{th} folding unit
Φₗ specific leading axle position
Φₗ′ leading axle position, desired angular position
a leading axle
b leading axle
M drive motor

What is claimed is:

1. A drive device of a printing press, having at least one virtual leading axle (a; b) for presetting a desired angular position (Φₗ′) of a drive (08) of at least one unit (01; 02; 03; 04; 06; 07) driven by its own drive motor (M), wherein the leading axle (a; b) is connected to at least one circuit (15; 20), which is able to convert the chronologically changing datum for the angular position of a leading axle position (Φ) into a pulse train (l(t); l₀(t)) in the form of output signals (I(t); l₀(t)) and it is possible to parameterize the circuit (15; 20) with regard to the number of pulses per rotation (n/2π).

2. The drive device as recited in claim 1, wherein the pulse train (l(t); l₀(t)) is supplied to a drive of a subassembly (19), which is independently driven by the drive (08) of the unit (01; 02; 03; 04; 06; 07) that is coupled to the leading axle (a; b).

3. The drive device as recited in claim 1, wherein the circuit includes a number of subcircuits that are able to generate a number of pulse trains (l(t)) in the form of output signals (l(t)) at a number of outputs.

4. The drive device as recited in claim 1, wherein the circuit (15; 20) or subcircuit is adjustable with regard to additional parameters (n/2π, τ, l, lₙ(t), “0”) that relate to the shape of the output signal (l(t)).

5. The drive device as recited in claim 1, wherein the circuit (15; 20) or subcircuit is embodied in the form of an emulator circuit.

6. The drive device as recited in claim 1, wherein the input of the circuit (15; 20) or subcircuit receives the current leading axle position (Φ) from a drive control unit (13) or a computing and data processing unit (11) of the printing press.

7. The drive device as recited in claim 1, wherein the circuit (15; 20) is connected as a client to a network (09) that conveys the leading axle position (Φ) and receives its angular position at its input.

8. The drive device as recited in claim 1, wherein a drive control unit (13) that presets the leading axle position (Φ) is provided, which has at least one circuit (15; 20).

9. The drive device as recited in claim 1, wherein a first and at least one second circuit (20; 15) are provided for conversion purposes.

10. The drive device as recited in claim 9, wherein a drive control unit (13; 17) that presets the leading axle position (Φ) has a first circuit (20), which converts the chronologically changing datum of the leading axle position (Φ) into a first pulse train (l₀(t)) with a fixed, definite number of pulses per rotation (n/2π) of the leading axle (a; b).

11. The drive device as recited in claim 10, wherein an output of the first circuit (20) communicates with the input of a second circuit (15), which is able to convert the first pulse train (l₀(t)) into a new pulse-shaped output signal (l(t)) in conjunction with parameters (n/2π, τ, l, lₙ(t), “0”) that influence the shape.

12. The drive device as recited in claim 3, wherein the second circuit (15) has a number of subcircuits, which are able to generate a number of different pulse trains (l(t)) in the form of output signals (l(t)) at a number of outputs.

13. The drive device as recited in claim 11, wherein the parameters (n/2π, τ, l, lₙ(t), “0”) of the circuit (15) or its subcircuits are adjustable.

14. The drive device as recited in claim 1, wherein it is possible to parameterize the output signal (l(t)) with regard to the number of output pulses per rotation (n/2π) of the leading axle (a; b).

15. The drive device as recited in claim 1, wherein it is possible to parameterize the circuit (15; 20) with regard to the number of pulses per rotation (n/2π) of a subassembly (19) to be controlled by means of the circuit (15; 20).

16. The drive device as recited in claim 4, wherein it is possible to parameterize the output signal (l(t)) with regard to a height of its amplitude (l).

17. The drive device as recited in claim 1, wherein the converted pulse train (l(t)) is present at the output of the circuit (15; 20) in the form of a digital output signal (l(t)).

18. The drive device as recited in claim 1, wherein the converted pulse train (l(t)) is present at the output of the circuit (15; 20) in the form of an analog output signal (l(t)).

19. The drive device as recited in claim 1, wherein the output signal (l(t)) at an output has a set of correlated pulse trains (l_{A}(t); l_{B}(t); l_{C}(t)).

20. The drive device as recited in claim 4, wherein the circuit (15; 20) is detachably connected to a computing unit (11) in order to adjust the parameters (n/2π, τ, l, lₙ(t), “0”).

21. The drive device as recited in claim 1, wherein the leading axle position (Φ) is preset by a drive control unit (13; 17).

22. The drive device as recited in claim 10, wherein the drive control unit (13; 17) that presets the leading axle position (Φ) is embodied in the form of an independent master for all of the drives (08) that are coupled to this leading axle (a; b).

23. The drive device as recited in claim 10, wherein the drive control unit (17) that presets the leading axle position (Φ) is embodied as a drive control unit (17) of a folding unit (06).

24. A method for controlling a subassembly of a printing press having at least one virtual leading axle (a; b) for presetting a desired angular position (Φₗ′) of a drive (08) of at least one unit (01; 02; 03; 04; 06; 07) driven by its own drive motor (M),
wherein at least one circuit (15; 20) connected to the leading axle (a; b) converts the chronologically changing datum for the angular position of a leading axle position (Φ) into a pulse train (l(t); l₀(t)) and supplies it in the form of output signals (l(t); l₀(t)) to the subassembly (19) and an incremental resolution between the rotating leading axle (a; b) and an angular position transducer of a subassembly (19) to be controlled via the circuit (15; 20) and/or its drive motor is performed by parameterizing the circuit.
